(19) United States
(12) Patent Application Publication
(10) Pub. No.: US 2024/0320465 A1
(43) Pub. Date: Sep. 26, 2024

(54) METHOD FOR PROVIDING A NEURAL NETWORK ON A DATA PROCESSING DEVICE

(71) Applicant: Robert Bosch GmbH, Stuttgart (DE)

(72) Inventors: Sebastian Boblest, Duernau (DE); Benjamin Wagner, Friedrichshafen (DE); Duy Khoi Vo, Stuttgart (DE); Ulrik Hjort, Malmo (SE); Dennis Sebastian Rieber, Albstadt (DE); Walid Hussien, Fellbach (DE)

(21) Appl. No.: 18/595,673

(22) Filed: Mar. 5, 2024

(30) Foreign Application Priority Data
Mar. 20, 2023 (DE) 10 2023 202 443.8

(51) Int. Cl. G06N 3/04

(52) U.S. Cl. CPC G06N 3/04

(57) ABSTRACT

A method for providing a neural network on a data processing device. The method includes: ascertaining, from a set of implementation variants of the neural network, a subset with a plurality of implementation variants of the neural network, wherein each implementation variant of the subset cannot be improved with respect to any of main memory requirement, non-volatile memory requirement, and execution time, when executed on the data processing device, without impairing at least one of the other two, and the subset for each of main memory requirement, non-volatile memory requirement and execution time, when executed on the data processing device, contains at least one particular implementation variant that is optimal in this respect from the set of implementation variants; selecting one of the ascertained implementation variants according to a user input that specifies a selection from the subset; and storing the selected implementation variant in the data processing device.

### CROSS REFERENCE

The present application claims the benefit under 35 U.S.C. § 119 of German Patent Application No. DE 10 2023 202 443.8 filed on Mar. 20, 2023, which is expressly incorporated herein by reference in its entirety.

### FIELD

The present disclosure relates to methods for providing a neural network on a data processing device.

### BACKGROUND INFORMATION

Neural networks can be used for numerous tasks, in particular control tasks such as driving assistance, robot control, or other controls of any type of machine. Different implementations of “the same” neural network (i.e., the implementations provide the same output from the same input) can have very different requirements regarding main memory, non-volatile memory, and execution time. Depending on the application and available hardware, i.e., the data processing device (e.g., a microcontroller) that is intended to execute the neural network, these requirements can be met more or less well or are of greater or lesser importance depending on the application. Procedures that allow a neural network to be suitably provided on a given data processing device are therefore desirable.

### SUMMARY

According to various embodiments of the present invention, a method for providing a neural network on a data processing device is provided, comprising: ascertaining, from a set of implementation variants of the neural network, a subset with a plurality of implementation variants of the neural network, wherein each implementation variant of the subset cannot be improved with respect to any of main memory requirement, non-volatile memory requirement and execution time, when executed on the data processing device, without impairing at least one of the other two of main memory requirement, non-volatile memory requirement and execution time, and the subset for each of main memory requirement, non-volatile memory requirement and execution time, when executed on the data processing device, contains at least one particular implementation variant that is optimal in this respect from the set of implementation variants. The method further comprises selecting one of the ascertained implementation variants according to a user input that specifies a selection from the subset, and storing the selected implementation variant in the data processing device.

The above-described method allows efficient provision of a neural network on a data processing device, taking into account technical conditions of the data processing device and the application in question (e.g., the device to be controlled by the data processing device). A user is given the possibility of selecting an implementation variant that is optimal (within the scope of the ascertainment accuracy or the available implementations) with regard to the available data processing device and the application in question (and the resulting prioritization of main memory requirement, non-volatile memory requirement and execution time).

The data processing device uses the neural network, for example, for a control task, i.e., for controlling a device such as a robot.

Various exemplary embodiments of the present invention are specified below.

Exemplary embodiment 1 is a method for providing a neural network, as described above.

Exemplary embodiment 2 is a method according to exemplary embodiment 1, comprising ascertaining a set of layers of the neural network that, when the neural network is implemented according to a reference implementation, have a longer execution time than the other layers of the neural network on the data processing device, ascertaining different layer implementation variants for each layer of the set, ascertaining implementation variants of the neural network by combining the ascertained layer implementation variants to form an implementation variant of the neural network, wherein a corresponding predefined standard implementation is used for layers that are not part of the set, and ascertaining the subset of implementation variants by ascertaining the main memory requirement, non-volatile memory requirement and execution time for each of the ascertained implementation variants (and adding the ascertained implementation variant to the subset, so that the subset or the implementation variants contained therein meet the above conditions).

This allows the subset to be ascertained sufficiently in particular in that only layer implementation variants are ascertained for layers whose execution time (i.e., computing effort) contributes most to the total execution time, e.g. above a predefined threshold (e.g., 1%-5% of the total execution time). For example, layer implementation variants that are each optimal with regard to at least one of main memory requirement, non-volatile memory requirement and execution time can be combined in order to generate the subset of implementation variants (or at least candidates of implementation variants for the subset of implementation variants, which are then added to the subset such that the subset or the implementation variants contained therein meet the above conditions). For ascertaining the main memory requirement, the non-volatile memory requirement and the execution time, the layers are implemented in accordance with the ascertained layer implementations.

Exemplary embodiment 3 is a method according to exemplary embodiment 1 or 2, wherein all implementation variants of the set of implementation variants supply the same output from the output layer of the neural network (i.e., numerically identical) for the same input to the input layer of the neural network.

This ensures that no accuracy is lost by optimizing the implementation of a neural network according to the above method.

Exemplary embodiment 4 is a method according to one of exemplary embodiments 1 to 3, wherein the implementation variants differ in at least one of
the set of layers that are implemented by means of the same calculation function;
the set of layers that are implemented by means of a respective calculation function adapted to the input variable, output variable and/or one or more quantization parameters of the layer and/or parameters such as the kernel size in convolutions;
the data type with which weights are stored in the main memory; and
the set of layers whose calculations are implemented by means of a lookup table.

These parameters have an effective influence on main memory requirement, volatile memory requirement and execution time without changing the output of the neural network. The data type decides, for example, whether the weights need more storage space but can be loaded directly into the processor.

Exemplary embodiment 5 is a method according to one of exemplary embodiments 1 to 4, comprising receiving a specification of a restriction of the data processing device with respect to at least one of non-volatile memory and main memory (e.g. by receiving a corresponding user input) and ascertaining the subset of implementation variants such that the implementation variants of the subset comply with the restrictions.

It can thus be ensured that the implementation variants from which the selection is made correspond to the capabilities of the data processing device.

Exemplary embodiment 6 is a method according to one of exemplary embodiments 1 to 5, comprising receiving a specification of an application request with respect to at least one of maximum computing time, maximum non-volatile memory requirement and maximum main memory requirement (e.g. by receiving a corresponding user input) ascertaining the subset of implementation variants such that the implementation variants of the subset satisfy the application request.

It can thus be ensured that the implementation variants from which the selection is made correspond to the requirements of the particular application (i.e., the particular task of the neural network).

Exemplary embodiment 7 is a computer system that is configured to carry out a method according to one of exemplary embodiments 1 to 6.

Exemplary embodiment 8 is a computer program comprising commands that, when executed by a processor, cause the processor to carry out a method according to one of exemplary embodiments 1 to 6.

Exemplary embodiment 9 is a computer-readable medium that stores commands that, when executed by a processor, cause the processor to carry out a method according to one of exemplary embodiments 1 to 6.

In the figures, similar reference signs generally refer to the same parts throughout the various views. The figures are not necessarily true to scale, with emphasis instead generally being placed on the representation of the main features of the present invention. In the following description, various aspects are described with reference to the figures.

### BRIEF DESCRIPTION OF THE DRAWINGS

FIG. 1 shows a device with a microcontroller, according to an example embodiment of the present invention.

FIG. 2 shows a schematic diagram of a Pareto front.

FIG. 3 shows a flowchart illustrating a method for providing a neural network on a data processing device according to one example embodiment of the present invention.

### DETAILED DESCRIPTION OF EXAMPLE EMBODIMENTS

The following detailed description relates to the figures, which show, by way of explanation, specific details and aspects of this disclosure in which the present invention can be executed. Other aspects may be used and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects.

Various examples are described in more detail below.

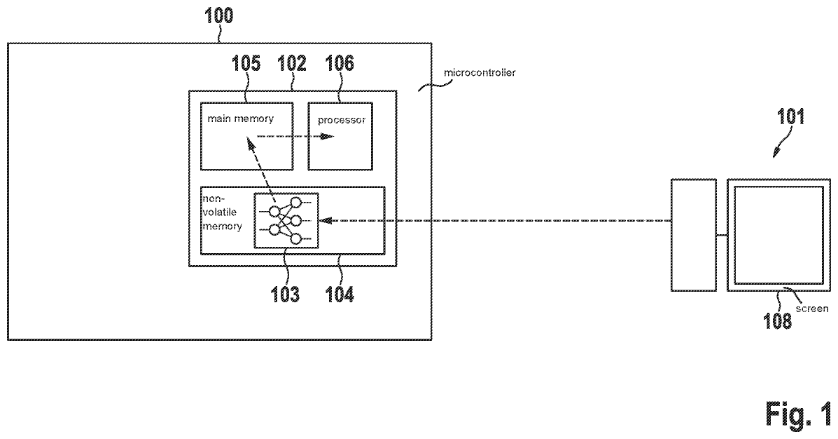

FIG. 1 shows a device 100 with a microcontroller 102.

The device 100 can be any type of robot device and/or machine, for example a vehicle, a robot arm, a washing machine, a drilling machine, etc. The microcontroller 102 can have any control task in such a device, for example controlling a brake, a motor, etc.

The microcontroller 102 uses a neural network 103 for this purpose. This is stored (in the form of a specification of the neural network, in particular its weights) in a non-volatile memory 104 (e.g., flash memory) of the microcontroller 102, is loaded into a main memory 105 (i.e., a RAM) of the microcontroller 102, for execution (e.g., when the device is switched on), and is executed by a processor 106 (this can also be a plurality of single processors or processor cores).

Microcontrollers are at the lower end of the power scale with respect to computing power, flash size, and RAM size. Software for this hardware is therefore limited in three directions. Neural networks on the other hand are computationally intensive. They have a high main memory requirement due to the activations to be stored and a high flash requirement due to the trained parameters. Their use on microcontrollers limits the number of layers and the layer size. In order to save further computing time, RAM, and flash, int8-quantized networks instead of float32 networks are used in most cases.

It is furthermore possible to implement a given neural network in different ways. These implementations are identical, to the bit, with respect to the numerical result (i.e., supply the same results for the same input) but differ with respect to computing time, main memory requirement, and non-volatile memory requirement. The implementation can thus be further adapted to the requirements within the overall system in question (here the device 100). Examples of the various requirements are:
The neural network 103 is called up very often, for example once per revolution of a drilling machine or a washing machine. In this case, the computing time is the most important criterion.
The neural network 103 is only required once when the device 100 is switched on, for example for self-diagnosis. The computing time is then not critical, and the main memory is secondary, since it can be used again later by other functions. However, the non-volatile memory requirement should be minimized as far as possible in order to have space for other functions.
The neural network 103 is to be used in a device 100 that has to keep a large amount of data in the main memory during the operating time. The main memory requirement is then the primary criterion.
The neural network is to run as efficiently as possible, but a maximum of 20 kB flash can be used for this purpose.

The implementation of a neural network for microcontrollers often takes place not manually, but with specially developed tools, which are however not able to generate different implementations with different compromises between computing time, main memory requirement and non-volatile memory requirement. Although a neural network can be compressed by quantization, this changes the numerical results of the neural network.

According to various embodiments, different implementations of a neural network are generated automatically, e.g. by a computer system 101. In contrast to quantization and pruning techniques, all implementations are numerically exactly identical (i.e., they deliver the same output with the same input). However, they differ in the required computing time, the main memory requirement, and the non-volatile memory requirement. In this case, of all possible implementations, those that lie on the Pareto front (computing time, main memory requirement and non-volatile memory requirement) are selected. If there is an excessively large number of implementations on the Pareto front, very similar implementations are then removed from these.

The resulting set of implementations is made available for selection to the user in question together with a list of computing time, main memory requirement and non-volatile memory requirement, e.g. on a screen 108 of the computer system 101. According to a user input, an implementation can then be selected and loaded onto the microcontroller 102 (by connection by means of a cable, wirelessly, by means of a USB stick, etc.) For example, the computer system 101 generates C code for a neural network 103 in order ultimately to be able to install the trained neural network 103 (according to the selected implementation) on microcontrollers. According to one embodiment, the computer system 101 does not generate one implementation here but rather a set of numerically identical implementations on the Pareto front (in the space spanned by computing time, main memory requirement and non-volatile memory requirement). For the implementations generated, the properties (computing time, main memory requirement, non-volatile memory requirement) are listed for the user, and/or the Pareto front is displayed graphically on the display 108.

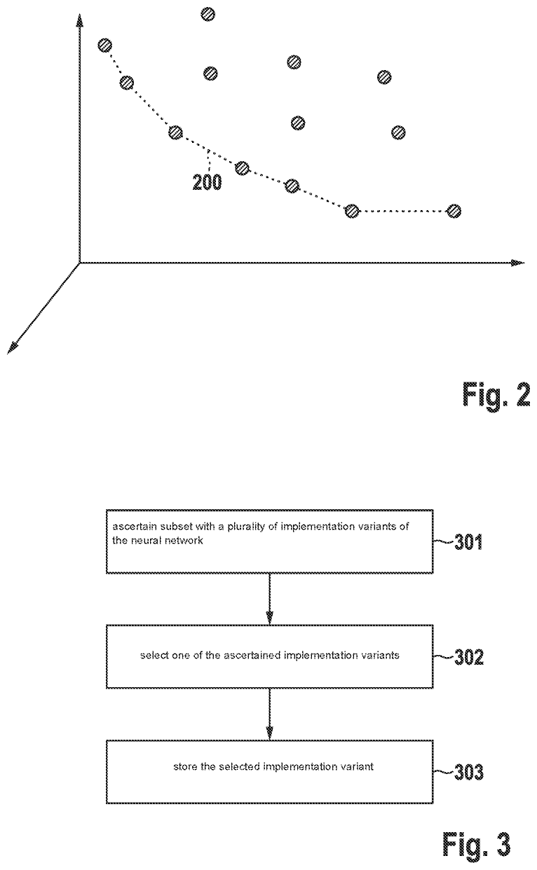

FIG. 2 shows a schematic diagram of such a Pareto front 200. The parameters are computing time, main memory requirement and non-volatile memory requirement. The implementations on the Pareto surface, in this case shown with dots and two-dimensionally in a simplified manner, are suggested to the user for selection.

The user can then select the implementation that best corresponds to their requirements (or to those of the device 100). Possible techniques to generate different implementations are:
To save non-volatile memory, all layers of one type (e.g. a fully connected or convolution layer) can be implemented with only one function that is called up for all layers (e.g., a function from a library).
To improve computing time at the expense of the non-volatile memory requirement, all of the layers of one type can be implemented with one unique optimized function each, which is adapted to the input variable and output variable and the quantization parameters as well as parameters such as the kernel size in convolutions.
To save computing time at the expense of the main memory, the weights of a particularly computationally complex layer can be permanently loaded into the main memory so that they are more rapidly available to the processor 106 during the calculation.
Certain layers may be implemented either algorithmically (long computing time, low non-volatile memory requirement) or using a lookup table (short computing time, high non-volatile memory requirement).

The various implementations can be sorted easily by layer with respect to the inference time (i.e., execution time of a forward pass through the neural network). The non-volatile memory requirement depends on the overall configuration but can be estimated relatively well, since the required storage amount for individual layers is relatively constant (two different highly optimized dense implementations, adapted to the input and output variables, have virtually the same non-volatile memory requirement if undetermined code parts can be optimized away). The main memory requirement of an implementation results from the set of activations to be stored and can be measured exactly. The parameters of different possible implementations can be determined and listed from the information for the individual layers.

The above-described approach accommodates the diverse requirements in various applications:
The implementation to be selected depends on the target hardware. Different microcontrollers can have a very different amount of non-volatile memory (e.g. flash memory).
Some applications have strict requirements such as a limitation of the flash memory to 20 kB or a maximum inference time of 6 ms.
Other applications have less specific requirements and require an implementation that is as fast as possible and requires little non-volatile memory. If sufficient reserves are still available, a larger neural network can optionally be selected.

However, an optimization with respect to a single target variable such as “optimize with respect to code size”, “optimize with respect to speed” as in the case of compilers, thus falls short. On the other hand, the approach described above avoids a situation in which the user is burdened with a large number of options that define the particular implementation by the user being able to select an implementation from a Pareto surface (i.e., Pareto front).

The determination of the Pareto surface can take place, for example, taking into account the following properties:
The runtime of the execution of the neural network 103 (i.e., an inference by means of the neural network) is the sum of the runtimes of the individual layers except for insignificant deviations.
The entire non-volatile memory requirement is composed of the non-volatile memory requirement of all trained parameters (typically the weights) and the non-volatile memory requirement of the implemented functions (e.g., layer operations). This is independent of whether layers share an implementation or each layer has a separate implementation: The set of required non-volatile memories is calculated as the memory requirement of the parameters plus the memory requirement of the required implemented functions. With a separate implementation for each layer, there is a function per layer, otherwise a function for a plurality of layers. The flash requirement can be ascertained easily from the functions and parameters used: If, for example, there is one function for two layers in one implementation and two functions in another implementation, then the additional flash requirement is that of the additional function. There are no interactions with other layers of the network as in the main memory requirement.
The main memory requirement is a global property. An increased main memory requirement of a single layer does not necessarily increase the total main memory requirement since the memory region can optionally be reused by other layers.

The computer system 101 determines the subset of implementation variants that are offered to the user for selection, for example as follows:
1. It sorts the layers of the neural network 103 according to the probable computing requirement. This can be determined by measuring a reference implementation of a particular layer on the target hardware (i.e., on the microcontroller 102).
2. Starting from the layer with the highest computing requirement, the computer system 101 generates, layer for layer, different implementations of the neural network 103 and measures or calculates the non-volatile memory requirement, the local main memory requirement of the currently implemented layer, and the computing time. I.e., the computer system 101 ascertains different implementations for each layer (also referred to herein as a layer implementation to distinguish it from the implementation of the entire neural network). For frequently occurring layer configurations, these values can also be stored in a database.
3. For layers that contribute to the overall computing requirement below a certain limit (approximately 1%-5%), the computer system 101 can directly provide a standard implementation that is memory-saving (main memory and non-volatile memory) to prevent the number of layer implementations and implementations of the neural network to be considered becoming too large.
4. The computer system 101 then combines the found layer implementations with one another to form implementations of the neural network 103. In order to determine the main memory requirement, a memory plan is calculated for each combination (i.e., each implementation of the neural network 103).
5. From the determined triplets (inference time, main memory requirement, non-volatile memory requirement), the computer system 101 calculates a Pareto front and gives the user only the implementations (of the neural network) on the Pareto front for selection (e.g. on the display 108). The calculation of the Pareto front can be performed with a standard library, e.g. OApackage for Python.

In summary, according to various embodiments, a method is provided as shown in FIG. 3.

FIG. 3 shows a flowchart 300 illustrating a method for providing a neural network on a data processing device according to one embodiment.

In 301, a subset with a plurality of implementation variants of the neural network is ascertained from a set of implementation variants of the neural network (i.e., a subset of the set of implementation variants, so that the subset itself contains a plurality of implementation variants; in the above examples these are the implementation variants on the Pareto front) , wherein
each implementation variant of the subset cannot be improved with respect to any of main memory requirement (e.g., RAM requirement), non-volatile memory requirement (e.g. flash requirement) and execution time (i.e., computing effort, e.g., the execution time of a forward pass through the neural network, i.e., an inference by means of the neural network) when executed on the data processing device, without impairing at least one of the other two of main memory requirement, non-volatile memory requirement and execution time, and
the subset for each of main memory requirement, non-volatile memory requirement and execution time when executed on the data processing device contains at least one particular implementation variant that is optimal in this respect out of the set of implementation variants.

In 302, one of the ascertained implementation variants is selected according to a user input (e.g. text input or click on a corresponding display element) that specifies a selection from the subset.

In 303, the selected implementation variant is stored in the data processing device (so that it can be executed there, e.g., it is transmitted from a computer system carrying out the above steps to the data processing device and stored there, e.g. by a flash process).

The provision of the neural network on the data processing device comprises the implementation according to various embodiments or is given thereby in various embodiments (storing the implementation variant in the data processing device can also be regarded as provision and in particular implementation of the implementation variant (or the neural network according to the implementation variant) on the data processing device).

According to various embodiments, the subset forms a Pareto surface in the set of (e.g., possible or available or provided) implementation variants.

The method of FIG. 3 may be performed by one or more computers with one or more data processing units. The term “data processing unit” may be understood as any type of entity that enables processing of data or signals. The data or signals can be treated, for example, according to at least one (i.e. one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail herein may also be understood as a data processing unit or logic circuit assembly. One or more of the method steps described in detail here can be executed (e.g. implemented) by a data processing unit by one or more special functions that are performed by the data processing unit.

The method is therefore in particular computer-implemented according to various embodiments.

The approach of FIG. 3 serves to provide a neural network on a data processing device, which then executes it and generates a control signal for a robot device for example on the basis of an output of the neural network (e.g., an object detection). The term “robot device” may be understood to refer to any technical system (comprising a mechanical part whose movement is controlled), such as a computer-controlled machine, a vehicle, a household appliance, a power tool, a manufacturing machine, a personal assistant or an access control system. A control rule for the technical system is learned, and the technical system is then controlled accordingly.

For example, the neural network can process sensor signals from different sensors, such as video, radar, LiDAR, ultrasound, motion, thermal imaging, etc., for example in order to obtain sensor data regarding states of a system to be controlled (e.g., a robot and objects in its surroundings). The processing of the sensor data can comprise for example the classification of the sensor data or the performance of a semantic segmentation of the sensor data, for example in order to detect the presence of objects (in the environment in which the sensor data were obtained). For example, a robot can thus be controlled by means of the neural network, for example in order to achieve different manipulation tasks under different scenarios. In particular, embodiments are applicable to the control and monitoring of the performance of manipulation tasks, for example, in assembly lines.

What is claimed is:

1. A method for providing a neural network on a data processing device, comprising the following steps:
ascertaining, from a set of implementation variants of the neural network, a subset with a plurality of implementation variants of the neural network, wherein each implementation variant of the subset cannot be improved with respect to any of main memory requirement, non-volatile memory requirement, and execution time, when executed on the data processing device, without impairing at least one of the other two of the main memory requirement, the non-volatile memory requirement, and execution time, and the subset, for each of the main memory requirement, the non-volatile memory requirement, and the execution time, when executed on the data processing device, contains at least one particular implementation variant that is optimal in this respect from the set of implementation variants;
selecting one of the ascertained implementation variants according to a user input that specifies a selection from the subset; and
storing the selected implementation variant in the data processing device.

2. The method according to claim 1, further comprising the following steps:
ascertaining a set of layers of the neural network that, when the neural network is implemented according to a reference implementation, have a longer execution time than other layers of the neural network on the data processing device;
ascertaining different layer implementation variants for each layer of the set of layers;
ascertaining implementation variants of the neural network by combining the ascertained layer implementation variants to form an implementation variant of the neural network, wherein a corresponding predefined standard implementation is used for layers that are not part of the set; and
ascertaining the subset of implementation variants by ascertaining the main memory requirement, the non-volatile memory requirement, and the execution time for each of the ascertained implementation variants.

3. The method according to claim 1, wherein all implementation variants of the set of implementation variants supply the same output from the output layer of the neural network for the same input to the input layer of the neural network.

4. The method according to claim 1, wherein the implementation variants differ in at least one of
a set of layers that are each implemented for the same calculation function;
a set of layers that are each implemented for of a respective calculation function adapted to an input variable, and/or an output variable, and/or one or more quantization parameters of the layer;
a data type with which weights are stored in the main memory;
a set of layers whose calculations are implemented using a lookup table.

5. The method according to claim 1, further comprising:
receiving a specification of a restriction of the data processing device with respect to at least one of non-volatile memory and main memory and ascertaining the subset of implementation variants such that the implementation variants of the subset comply with the restrictions.

6. The method according to claim 1, further comprising:
receiving a specification of an application request with respect to at least one of a maximum computing time, a maximum non-volatile memory requirement, and a maximum main memory requirement; and
ascertaining the subset of implementation variants such that the implementation variants of the subset satisfy the application request.

7. A computer system configured to provide a neural network on a data processing device, the computer system configured to:
ascertain, from a set of implementation variants of the neural network, a subset with a plurality of implementation variants of the neural network, wherein each implementation variant of the subset cannot be improved with respect to any of main memory requirement, non-volatile memory requirement, and execution time, when executed on the data processing device, without impairing at least one of the other two of the main memory requirement, the non-volatile memory requirement, and execution time, and the subset, for each of the main memory requirement, the non-volatile memory requirement, and the execution time, when executed on the data processing device, contains at least one particular implementation variant that is optimal in this respect from the set of implementation variants;
select one of the ascertained implementation variants according to a user input that specifies a selection from the subset; and
store the selected implementation variant in the data processing device.

8. A non-transitory computer-readable medium on which are stored commands for providing a neural network on a data processing device, the commands, when executed by a computer, causing the computer to perform the following steps :
ascertaining, from a set of implementation variants of the neural network, a subset with a plurality of implementation variants of the neural network, wherein each implementation variant of the subset cannot be improved with respect to any of main memory requirement, non-volatile memory requirement, and execution time, when executed on the data processing device, without impairing at least one of the other two of the main memory requirement, the non-volatile memory requirement, and execution time, and the subset, for each of the main memory requirement, the non-volatile memory requirement, and the execution time, when executed on the data processing device, contains at least one particular implementation variant that is optimal in this respect from the set of implementation variants;
selecting one of the ascertained implementation variants according to a user input that specifies a selection from the subset; and
storing the selected implementation variant in the data processing device.
